(19) United States
(12) Patent Application Publication
(10) Pub. No.: US 2014/0308551 A1
(43) Pub. Date: Oct. 16, 2014

(54) SERIES COOLED MODULE COOLING FIN

(71) Applicant: GM GLOBAL TECHNOLOGY OPERATIONS LLC, Detroit, MI (US)

(72) Inventors: Elizabeth A. Schroeder, Sterling Heights, MI (US); Chih-Cheng Hsu, Rochester Hills, MI (US); John T. Guerin, Bloomfield, MI (US)

(73) Assignee: GM Global Technology Operations LLC, Detroit, MI (US)

(21) Appl. No.: 13/862,525

(22) Filed: Apr. 15, 2013

(51) Int. Cl. H01M 10/613; H01M 10/625

(52) U.S. Cl. CPC H01M 10/5004; H01M 10/5016
USPC 429/81; 165/109.1

(57) ABSTRACT

An automotive battery module with numerous battery cells and a series-based cooling fin arrangement placed in thermal communication with at least two of the battery cells. Heat generated within the battery cells by, among other things, electric current that can be used to provide motive power for the automobile, may be removed by the cooling fin that includes different portions tailored to remove relatively lesser or greater amounts of heat, depending on a potential temperature difference among the cells. The construction of the cooling fin is such that multiple heat transfer paths are established, each configured to convey heat away from the battery cells, as well as to keep temperature differences between adjacent series-cooled battery cells to a minimum. In one form, the multiple heat transfer paths may include a relatively laminar portion and a relatively turbulent portion, where in one form the increased turbulence may be obtained through numerous turbulators. Other such heat transfer paths may include an intermediate exhaust path, a discreet coolant channel or the like. Any or all of the turbulators, exhaust path or discreet coolant channel may be tuned in order to increase or decrease an amount of heat delivered to the cooling fin from the battery cells.

### BACKGROUND OF THE INVENTION

This invention relates generally to a cooling fin to enable series cooling of individual battery cells and battery modules within a battery pack, and more particularly to using such a cooling fin without introducing large temperature differences or pressure drops.

Lithium-ion and related batteries, collectively known as a rechargeable energy storage system (RESS), are being used in automotive applications as a way to supplement, in the case of hybrid electric vehicles (HEVs), or supplant, in the case of purely electric vehicles (EVs), conventional internal combustion engines (ICEs). The ability to passively store energy from stationary and portable sources, as well as from recaptured kinetic energy provided by the vehicle and its components, makes batteries ideal to serve as part of a propulsion system for cars, trucks, buses, motorcycles and related vehicular platforms. In the present context, a cell is a single electrochemical unit, whereas a battery is made up of one or more cells joined in series, parallel or both, depending on desired output voltage, current or capacity.

Temperature is one of the most significant factors impacting both the performance and life of a battery. Prolonged exposure to high temperature may lead to premature aging, accelerated capacity fade and other undesirable cell conditions. Forced air and liquid cooling may prove to be effective at avoiding such excessive heat buildup in and around the individual cells that make up a larger battery pack, but in so doing may exacerbate excessive temperature differential between cells within the same module, section or pack where—for example—it is desirable to keep temperature differences between adjacent cells relatively small, often to no more than about 5° C. Furthermore, while parallel-based cooling systems typically are able to avoid significant temperature differentials (due in part to there being an equal chance for the cooling fluid to travel in each parallel path) of the overall system, they could be susceptible to more complex ducting in order to provide the necessary even flow distribution.

### SUMMARY OF THE INVENTION

It is important for proper operation of a battery-based power system to keep operating voltages of the individual cells that make up the battery relatively close to one another. Likewise, because cell voltage drop is a function of resistance, and resistance is a function of temperature, it is desirable to keep the temperature of the cells close to one another in order to preserve this relative commonality of individual cell voltages. To this end, as well as to achieve a desirable balance between battery life and performance, the present inventors have determined that only small temperature variations between cells should be permitted. In one exemplary form based on current battery state-of-the-art, such differences should be (as mentioned above) kept to no more than about 5° Celsius, although subsequent improvements in cell technology may permit slightly larger disparities. Furthermore, the present inventors have determined that certain types of batteries—such as Li-ion batteries—operate best at temperatures between about 25° Celsius and about 40° Celsius. The cooling configuration of the present disclosure can be designed for a specific operating temperature that satisfies these requirements. As such, a battery cooling system based on the use of particularly-configured cooling fins can help maintain optimal operating temperatures and temperature uniformity of the cells within a battery under normal operating conditions, including minimizing heat differentials between neighboring cells. In both circumstances, this helps to mitigate thermal propagation and the related potential to damage additional components.

According to one aspect of the invention, a cooling system for a battery pack, section, module or related plurality of battery cells is disclosed. The battery includes two or more battery cells configured to deliver electric current, and the cooling system includes a cooling fin placed in thermal communication with the one or more of the various individual battery cells. The number of battery cells within the larger battery module, section, pack or related structure will be appreciated by those skilled in the art to coincide with the power needs of the device receiving electric current from the battery, as well as the thermal operating requirements of the cells within the battery.

As discussed above, battery packs are made up of sections which may be made up of numerous battery modules each of which is in turn made up of one or more battery cells that deliver electrical current to a load. One such non-limiting example of a load includes the equipment used to provide motive power to the powertrain of an automobile, as well as other auxiliary applications associated with operating the vehicle. In the present context, the term “motive power” describes a battery pack capable of providing more than mere starting power for another power source (such as an internal combustion engine); it includes battery packs capable of providing sustained power sufficient to propel a vehicle in a manner consistent with that for which it was designed. It will be appreciated by those skilled in the art that such batteries may also store energy recaptured from kinetic energy, such as regenerative braking or excess energy from an ICE. In one form, the current generated by the battery pack may be used to run one or more electric motors that in turn may be used to turn one or more wheels. Other members (for example, structural members) are placed in thermal communication with the battery cell to enable heat exchange between them.

According to another aspect of the invention, a propulsion system for an automobile is disclosed. The propulsion system includes one or more battery modules each of which is made up of one or more battery cells where an electrochemical reaction takes place, as well as a cooling fin placed in thermal communication with the battery cell or cells. The cooling fin includes a surface onto which (or into which) one or more coolant flow-paths may be formed, including a laminar portion and a turbulent portion. Depending on which (and how many) of the cells each cooling fin can provide face-to-face heat exchange with, the size and location of the cooling surface (also referred to as cooling fin surface) dedicated to the laminar and turbulent portions can be varied.

According to yet another aspect of the invention, a method of controlling temperature in an automobile propulsion system is disclosed. The method includes configuring the propulsion system to derive at least a portion of its motive power from one or more battery cells (which may in turn make up the successively larger units of a battery module and a battery pack), arranging a cooling fin to be in thermal communication with the battery cell, and transferring at least a portion of the heat contained within the at least one battery cell to the cooling fin. As with the previous aspects, the presence of laminar and turbulent portions (as well as their fractions of overall cooling fin surface area) is designed to coincide with the needs of the cells being cooled.

### BRIEF DESCRIPTION OF THE DRAWINGS

The following detailed description of the preferred embodiments of the present invention can be best understood when read in conjunction with the following drawings, where like structure is indicated with like reference numerals and in which:

FIG. 1 shows a vehicle with a hybrid propulsion system in the form of a battery pack and an internal combustion engine according to the prior art;

FIG. 2 is a simplified exploded view of the battery pack of FIG. 1;

FIG. 3 shows a notional parallel cooling arrangement for numerous aligned battery cells of the battery pack of FIG. 1;

FIG. 4 shows the series cooled module cooling fin according to an aspect of the present invention; and

FIG. 5 shows a cooling system according to one aspect of the present invention where a pair of side-by-side groups of battery cells are coupled to a series-based cooling scheme.

### DETAILED DESCRIPTION OF THE PREFERRED EMBODIMENTS

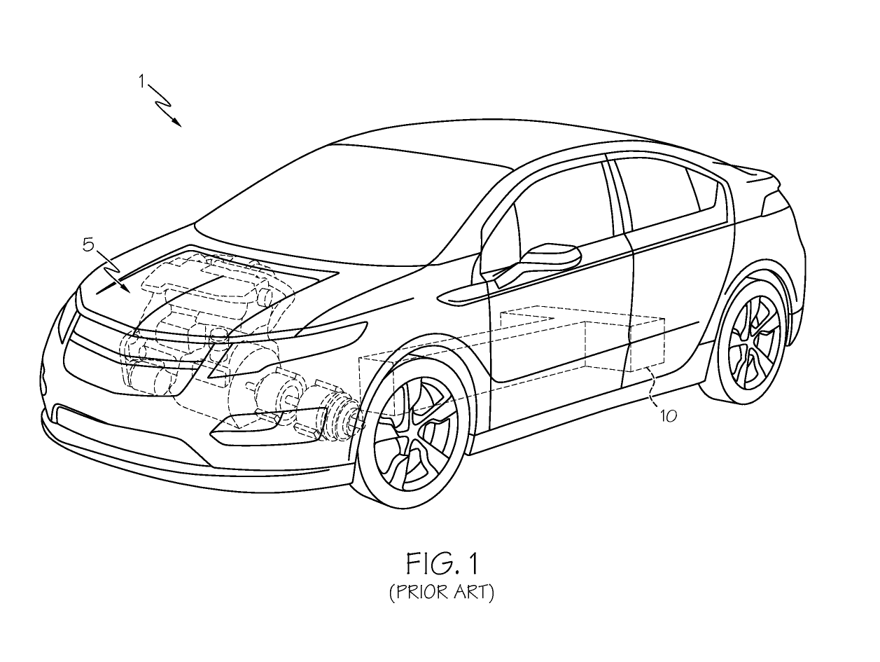

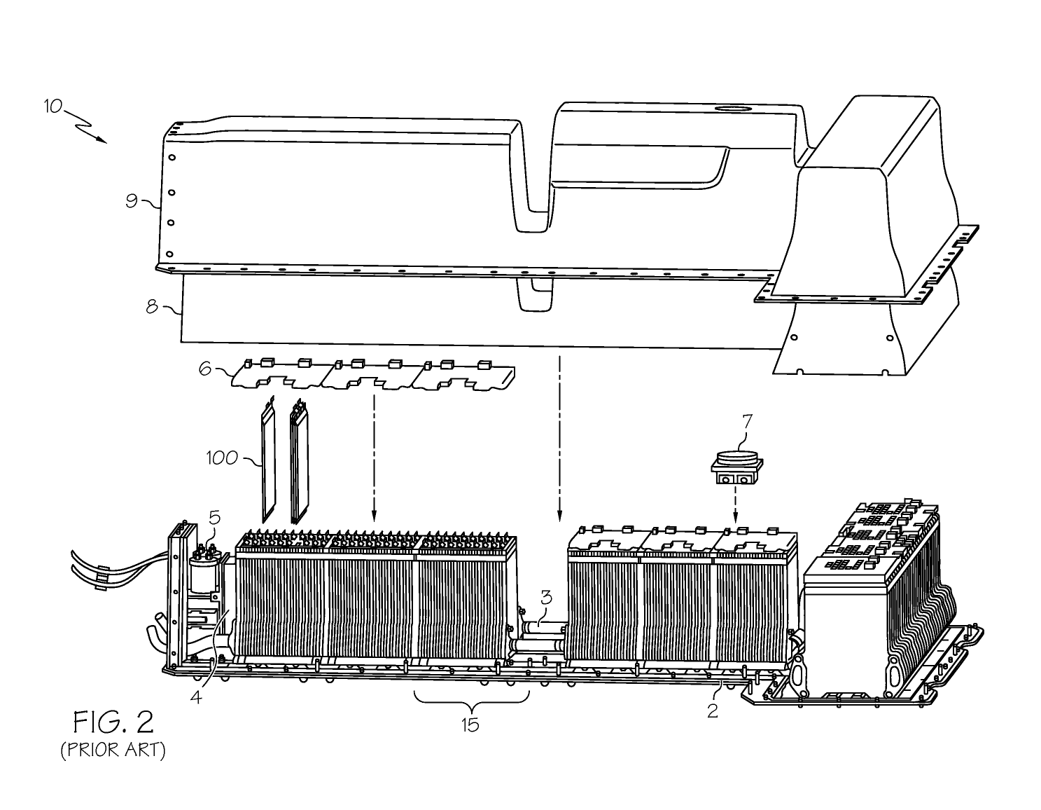

Referring first to FIGS. 1 and 2, a vehicle 1 including a hybrid propulsion system in the form of a battery pack 10 and a conventional ICE 5 in accordance with the prior art is shown. As mentioned above, such a vehicle 1 is known as an HEV. It will be further appreciated by those skilled in the art that vehicle 1 may not require an ICE 5; in such case, rather than being an HEV, it is an EV; either form is within the scope of the present invention. In the present context, the terms “battery cell”, “battery module” and “battery pack” (as well as their shortened variants “cell”, “module” and “pack”) are use to describe different levels of components of an overall battery-based power system, as well as their assembly. For example, numerous individual battery cells form the building blocks of battery modules (in conjunction with ancillary equipment) in turn make up the completed battery pack.

Referring with particularity to FIG. 2, battery pack 10 according to the prior art is shown in a partially-exploded view and employs numerous battery modules 15 with cells 100. Depending on the power output desired, numerous battery modules 15 may be combined into larger groups or sections; such may be aligned to be supported by a common tray 2 that can also act as support for coolant hoses, headers, manifolds or related conduit 3 where supplemental cooling may be desired. In the present context, the terms “battery cell”, “battery module” and “battery pack” (as well as their shortened variants “cell”, “module” and “pack”) are use to describe different levels of components of an overall battery-based power system, as well as their assembly. For example, numerous individual battery cells 100 form the building blocks of battery modules 15. Numerous battery modules 15 (in conjunction with ancillary equipment) in turn make up the completed battery pack 10. Other such sections, assemblies or related built-up battery structures are also possible.

A bulkhead 4 may define a primary support structure that can function as an interface for the coolant hoses 3, as well as house a battery disconnect unit in the event battery service is required. In addition to providing support for the numerous battery modules 15, tray 2 and bulkhead 4 may support other modules, such as a voltage, current and temperature measuring module 5. Placement of individual battery cells 100 (to be discussed in more detail below) within one of battery modules 15 is shown, as is the covering thereof by a voltage and temperature sub-module 6 in the form of plug connections, busbars, fuses or the like. Although shown notionally in a T-shaped configuration, it will be appreciated by those skilled in the art that battery pack 1 may be formed into other suitable configurations as well. Likewise, battery pack 1 may include—in an exemplary configuration—between about two hundred and three hundred individual battery cells 100, although (like the arrangement) the number of cells 100 may be greater or fewer, depending on the power needs of the vehicle. In one exemplary form, battery pack 1 is made up of three sections a first of which consists of two modules 10 with thirty six cells 100 in each module 15 to make a seventy two cell section located along the vehicular longitudinal axis of the T-shaped battery pack 1, a second of which consists of two modules 15 with thirty six cells 100 in each module 10 and one module with eighteen cells 100 to make a ninety cell section (also located along the vehicular longitudinal axis) and a third (located on the vehicular lateral axis of the T-shaped battery pack 1) made up of three modules 10 with thirty six cells 100 in each module 15 and one module with eighteen cells 100 to make a one hundred and twenty six cell section for a total of two hundred and eighty eight such cells. Other features, such as manual service disconnect 7, insulation 8 and a cover 9 complete the battery pack 1. In addition to the aforementioned battery disconnect unit, other power electronic components (not shown) may be used, including a battery management system or related controllers. The number of cells mentioned above in conjunction with battery pack 10 are meant to be exemplary; in one preferred form, a battery cell-based power system could employ a fewer number or a greater number of such cells; for example such a system may contain between about a dozen and two hundred of such cells.

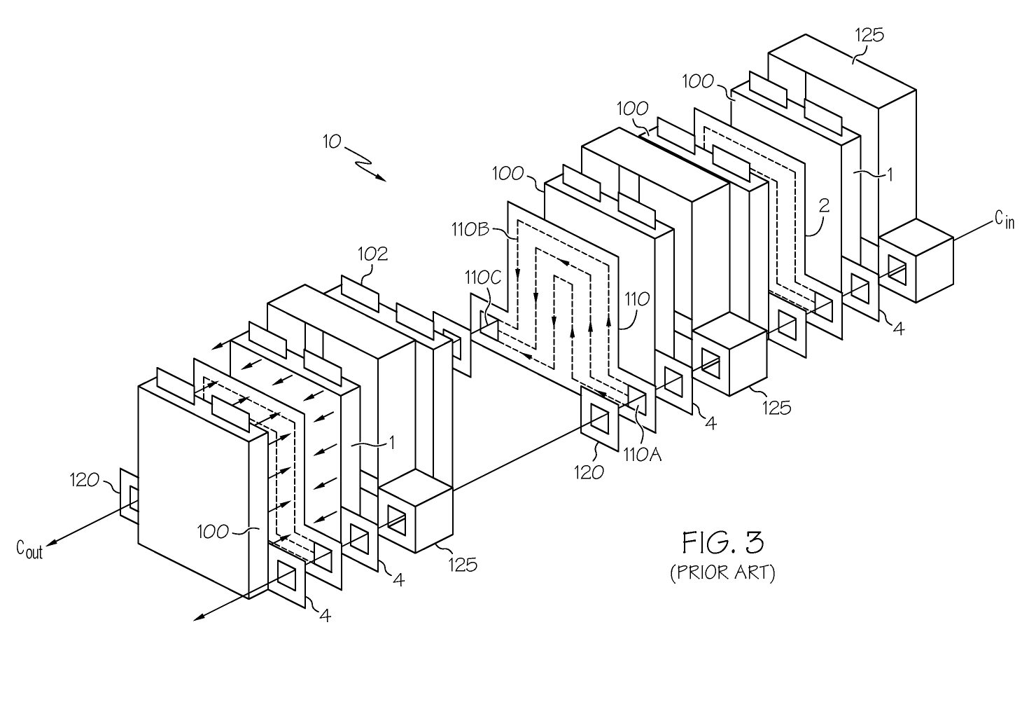

Referring next to FIG. 3, an exemplary form of a parallel cooling scheme of aligned battery cells 100 and their respective cooling fins 110 according to the prior art are shown. The cooling fins 110 are configured such that coolant that travels through an inlet header, manifold ore related conduit Cᵢₙ, enters each of the cooling fins 110 through inlet 110A and—after traversing a plurality of discreet coolant channels 110B—exits through outlet 110C such that the used coolant exits the cells 100 through an outlet header, manifold ore related conduit Cₒᵤₜ. In the present context, a cooling scheme is understood to define a parallel structure when every cell 100 is exposed to the cooling fluid that is of substantially the same inlet cooling temperature and flow. Contrarily, as will be discussed in conjunction with the present invention, a cooling scheme is understood to define a series structure when one or more subsequent cells 100 are exposed to the cooling fluid that has already been in thermal contact with one or more previous cells 100; in this way, the heat transfer from the previous cell 100 to the coolant causes the coolant as it approaches each subsequent cell 100 to be at least incrementally higher than it was when adjacent the previous cell 100. By adopting a purely parallel cooling structure, the device of FIG. 3 is well-suited to maximizing heat rejection with a minimum of coolant pressure drop; nevertheless, such construction is (as discussed above) susceptible to unacceptably high temperature differentials among the various cells 100 of the larger battery assembly if the uneven flow is distributed into each of the channels 110B. Other components are also shown, including seals 120, O-rings (or related devices) that may be used to improve leakage resistance between adjacent fins 110 or between an adjacent fin 110 and cell 100 pair. In one form, such seals 120 may be integrated into a frame 125, which holds the cells 100 and fins 110 in place in an aligned stack. In one exemplary form, two battery cells 100 and a cooling fin 110 can be contained in a frame 125.

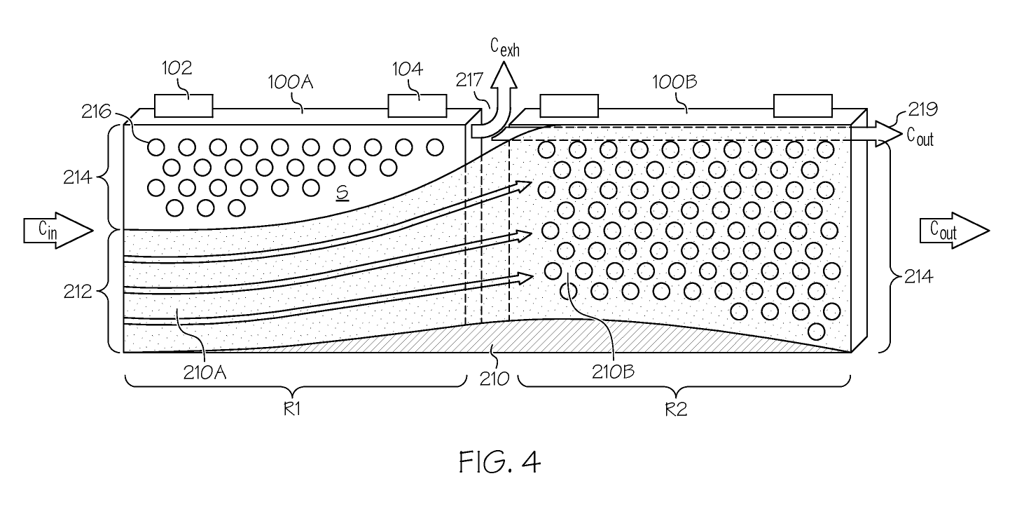

Referring next to FIG. 4, one embodiment of a series cooling configuration according to an aspect of the present invention for use with a side-by-side arrangement of battery cells 100 (with positive and negative electrodes or tabs 102 and 104) is shown. It will be appreciated that the prior art battery pack 10 of FIG. 2 and the vehicle 1 of FIG. 1 (both of which presently depict the aforementioned parallel cooling configuration) could be adapted to accommodate the cooling configuration of the present invention through suitable reconfiguration of the arrangement of the various battery cells 100. As such, the present description of these and other systems that could benefit from the present cooling fin configuration will be understood to be appropriately modified as needed and that the context dictates when such modification is made. For example, regardless of the whether the cells 100 are cooled in a series or parallel fashion, the cooling fin 110 (of the prior art of FIG. 3) 210 (of the present invention of FIG. 4) and the one or more battery cells 100 preferably define a substantially planar (i.e., plate-like) construction; such construction allows them to be stacked against one another (like a deck of cards) such that an adjacently-facing relation exists between them. Such facingly-adjacent construction maximizes surface area contact between the heat-generating cells 100 and the respective heat-receiving fins 110, 210. While both the prior art and present approaches bring the cells 100 into facing contact with cooling fin 110, 210 that in turn may include discreet channels or other paths through which coolant flows, what makes the arrangement different in the series cooling approach of the present invention is that two or more cells 100 (for example, leftmost cell 100A and rightmost cell 100B as shown in FIG. 4) are situated in a where the coolant flows sequentially past a first 100A of these cells and then on to a second 100B (as well as subsequent cells, not shown) before exiting the cooling system. In this way, the cell that requires a greater level of cooling in order to maintain it within a temperature range that is either (a) relatively close with one or more cells that require a lesser amount of cooling or (b) within a predetermined range can receive the concomitant amount of cooling. In the present version, the cells 100A and 100B are shown in a side-by-side relationship; however, such construction is not critical to the operation of the present invention, and other forms (such as U-shaped cooling fins, not shown) may also be employed. For example, the cell orientation (i.e., horizontally-stacked, vertically-stacked), as well as the number of cells situated in the side-by-side arrangement of FIG. 4), are deemed to be within the scope of the present invention.

Unlike the cooling fins 110 of FIG. 3 that solely define generally laminar flow discreet channels 110B, cooling fins 210A and 210B (generally 210) of the present invention can be arranged such that a generally planar surface S thereof that encounters the coolant C includes surface regions R1 and R2 that are possessive of one or both of a laminar flow portion 212 and a turbulent portion 214 formed thereon. As shown, a single cooling fin 210 has enough surface area to cover two cells 100A, 100B; in this way, the sequential passage of coolant C over the two cells 100A, 100B encounters the two different surface regions R1 and R2 such that in one of the regions, one of the first and second portions 212 or 214 predominates, while in the other region the other of the first and second portions 212 or 214 predominates. Such predominance of the laminar or turbulent attributes on the respective surface regions R1 and R2 may be made in accordance with the heat exchange requirements of the cells 100A, 100B. Thus, in one form where more heat needs to be removed from the second cell 100B, the turbulent portion 214 can be made to predominate over the respective surface region R2, whereas in situations where more heat needs to be removed from the first cell 100A, the turbulent portion 214 can be made to predominate in surface region R1. Similarly, in each of these two situations, the respective laminar portions 212 can be made to predominate in the opposing surface regions; either approach (as well as the density or related degree to which each of the laminar or turbulator-based attributes may be configured) is within the scope of the present invention. An optional feature may be built into the first-encountered cooling fin 210A to act as an insulator plate (not shown); such a plate would allow the cooling air to in effect be “saved” for the later-encountered cooling fin 210B such that the thermal integrity of the air passing over the first-encountered cooling fin 210A is preserved as much as possible by both keeping it laminar and shielding it from the environment of the adjacent cell 100A. Such a plate may be made from a low thermal conductivity material, such as a plastic or foam-based material.

With regard to the laminar portion 214, it is preferable to keep the air (or related coolant) C laminar and insulated while passing over the hotter first cell 100A in order to keep the heat exchange between the cell 100A and its adjacent cooling fin 210A relatively low. Numerous individual turbulators 216 may be formed on the part of surface S that defines the turbulent portion 214, and their spacing and size may be used to provide a tunable amount of flow disruption. In one form, this tunable feature may be made to occur across the face of the cooling fin 210 to help manage temperature from the bottom to top. In the present context, a turbulator—while shown as a semicircular bump—is any device that by its protrusion into the flow stream turns laminar flow into turbulent flow. As will be apparent from the discussion herein, such enhancement of turbulent flow helps to promote the exchange of heat between the various cells 100A, 100B and the coolant C that flows across the companion cooling fins 210A, 210B. This enhanced heat exchange in turn can be used to maximize cooling efficiency in strategic areas in order to promote better temperature uniformity among the various individual battery cells 100 by having the ratio between the laminar portion 212 and a turbulent portion 214 of the first-encountered cooling fin 210A be different from the ratio of the cooling fin 210B that later encounters the coolant C. In one form, the enhanced heat exchange between the second cell 100B and the adjacent cooling fin 210B can be quantified as heat rejection per degree inlet temperature differential; such a value may be used to provide tunable levels of heat removal from the various cells 100. Thus, with some knowledge about the cell 100 and its heat generation, the series cooling system of the present invention can be used to tune the amount of heat carried away from each series cell 100 to control the temperature differential from the first series cell 100A to the next series cell 100B and each subsequent cell in the series, all the way up to the last one in the group or related unit of cells 100. Although the latter cooling fin 210B is shown with a substantial majority of its surface S covered with turbulators 216, it will be appreciated that the number and surface S coverage can be tuned (i.e., made greater or fewer in number, size or related surface coverage), depending on the expected temperature difference across the adjacent cells 100A, 100B. Furthermore, the proximity of the placement of the turbulators 216 to the positive and negative electrodes or tabs 102 and 104 is such that the area defined by the turbulator 216 array may be adjacent the hottest part of the cell 100A as a way to best remove the most heat. It is likewise within the scope of the present invention to have the turbulators 216 be opposite of the positive and negative electrodes or tabs 102 and 104; in either event, the ability to configure such turbulator 216 placement d for each cell geometry is within the scope of the present invention.

In one form, the coolant C can be made to flow across a substantial entirety of each of the cells 100A, 100B such that a substantial entirety of incoming coolant Cᵢₙ, is also discharged at the outlet Cₒᵤₜ (which collectively define a coolant flow-path), while in another form, some of the coolant C may be exhausted Cₑₓₕ through an exhaust path 217 (also referred to herein as an intermediate exhaust path to emphasize its removal of excess heat as a way to reduce the chances of the downstream cell 100B from being exposed) fluidly disposed between the side-by-side cells 100A, 100B prior to encountering the cooling channel portion that is adjacent the second cell. This feature allows the heated coolant C to be exhausted in order to not contaminate the cool air in a manner generally similar to that of the “saved” or preserved air discussed above in conjunction with the insulator plate. As such, the placement of the exhaust path 217 along the coolant flow-path between the first and second of the battery cells 100A, 100B such that at least a portion of heat transferred from the first battery cell 100A to the coolant C is exhausted to prevent the contained in the coolant C from being delivered to the second battery cell 100B. In yet another form, it can be passed along a small diversional pathway in the form of a discreet channel 219 along the top of second cell as not impact the temperature of the second cell temperature. Exhaust path 217 may also be tuned (by, for example, adjusting the cross-sectional area or tortuous nature of its flow-path) to remove a certain fraction of the overall coolant flow, as can discreet channel 219 formed along the flow-path direction of the later-encountered cooling fin 214. In one form, the discreet channel 219 may be placed along an upper edge (as shown) of the later-encountered cooling fin 210B or elsewhere, depending on the need. In a particular form, the air that is adjacent the turbulators 216 in turbulent portion 214 of the first-encountered cooling fin 210A is hot relative to the more laminar flows in the laminar portion 212; by helping to route this hotter air away from the subsequently-encountered cooling fin 210B through the use of one or both of exhaust path 217 and discreet channel 219, the likelihood of undue heating of cell 100B is reduced.

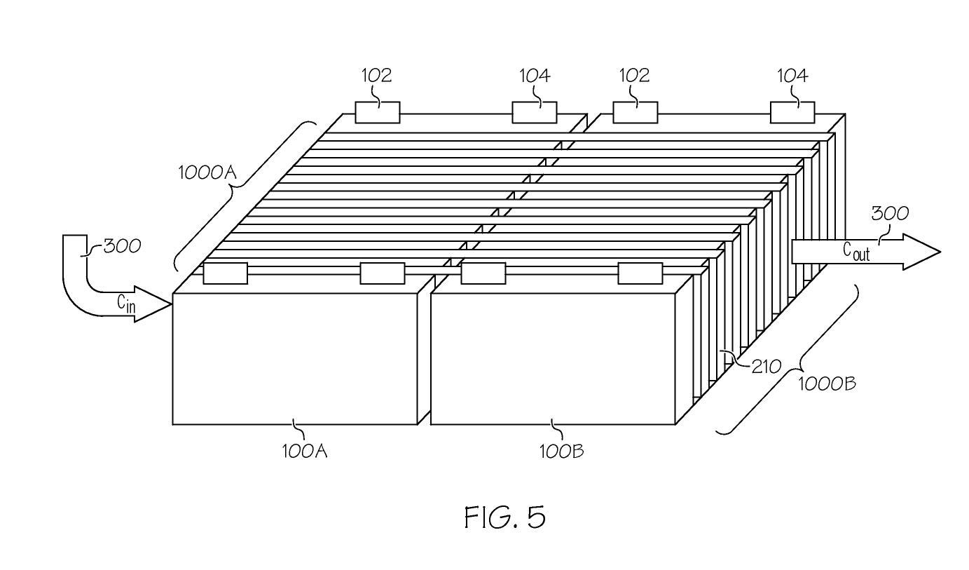

Referring next to FIG. 5, the placement of two side-by-side cell groups 1000A and 1000B (which in one form may be sized similar to module 15 shown in FIG. 2) made up of a stacked alignment of respective individual battery cells 100A and 100B is shown with most of the upwardly-extending tabs or electrodes 102, 104 removed for clarity. As can be seen, a respective number of cooling fins 210 are also aligned along an axis that is normal to the surfaces S that contain the laminar and turbulent portions 212 and 214. In one particular embodiment, a single fin 210 is used to cool two cells 100, while in another, cooling fin 210 may be made up of two (or more) fins 210A, 210B that are connected together to provide the air flow or related coolant C and related heat exchange function with the respective cells 100A, 100B. As such, the configuration of the present invention minimizes pressure drop and heat transfer balance by optimizing the cooling channels that define the laminar and turbulent flow portions 212, 214. This pressure drop is minimized by having the turbulence of the surface of the cooling fins 210A, 210B (or related media) used only where needed in order to ensure ample heat transfer, keeping in mind that while high turbulence is good for promoting heat exchange, it can have a deleterious impact on pressure drop. Such impact could—if not remedied—necessitate a larger fan, compressor or related blower to ensure adequate cooling flow. By the present invention, the judicious use of turbulence where needed, coupled with the preservation of laminar flow where high heat transfer is not needed, helps promote the desired levels of heat transfer without introducing unnecessary cost or complexity into the system. One advantage of the present invention is that by placing two cell groups 1000A and 1000B in a closely-packed lateral (i.e., side-by-side) arrangement as shown, significant reductions in the amount of required cooling duct 300 may be realized. In such construction, the duct 300 has an inlet duct and an outlet duct that extends across the cell groups 1000A and 1000B between each adjacent cell 100 and cooling fin 210 pair. In this way, at least one of the inlet and outlet portions of the cooling duct 300 may function as a header or manifold to permit the simultaneous introduction of coolant C into the various cell 100 and cooling fin 210 pairs that make up each of the cell groups 1000A and 1000B. As mentioned above, even though FIG. 5 presently shows a side-by-side grouping of adjacent cell groups, the present invention could also work in a top-to-bottom stacked arrangement as well Another advantage to the present cooling fin 210 construction associated with the side-by-side placement of groups 1000A and 1000B is that the fins 210 can be made of a singular piece of structure that extends all the way from the inlet side (i.e., the leftward-facing surface of group 1000A) to the outlet side (i.e., the rightward-facing surface of group 1000B), thereby eliminating the especially challenging placement of additional inlet or outlet ducting in the coolant flow-path gap between the cell groups 1000A, 1000B. This is additionally advantageous in that the cooling fins 210 used to define the portion of the cooling duct 300 that corresponds to the portion of the flow-path defined between group 1000A inlet and group 1000B outlet can be made to span or otherwise extend across the entire inlet or outlet face of both groups 1000A and 1000B, thereby keeping part count and related fabrication costs low. For example, by not having the cooling fins 210 span the gap between side-by-side cells in the cell groups 1000A, 1000B, significantly greater use of manifolds, ducting and related fluid-handling apparatus would be required; such additional complexity may make an otherwise viable series cooling approach unsuitable for use in the close confines associated with an automotive application. Furthermore, such construction does nothing to prevent the adjacent groups 1000A and 1000B from being electrically connected in either a parallel or series configuration.

One benefit of the present invention is its ability to maximize efficiency of a fan, compressor, blower or related flow-enhancing device while minimizing temperature differences between the first cell and the subsequent cell or cells. Such efficiency improvements may come about as a result of using one fin 210 to cool two cells 100A, 100B, which helps eliminate or reduce the size of the ducting used to carry the coolant C. This duct reduction in turn helps increase battery cell 100 packaging density, as well as permit simplified control by promoting a substantial increase in the uniformity of cell 100 temperatures with battery pack 10. Furthermore, overall component and manufacturing costs may be reduced by having reduced number of cooling fins 210.

It is noted that terms like “preferably”, “commonly” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. Likewise, terms such as “substantially” are utilized to represent the inherent degree of uncertainty that may be attributed to any quantitative comparison, value, measurement or other representation. It is also utilized to represent the degree by which a quantitative representation may vary from a stated reference without resulting in a change in the basic function of the subject matter at issue.

For the purposes of describing and defining the present invention it is noted that the term “device” is utilized herein to represent a combination of components and individual components, regardless of whether the components are combined with other components. For example, a device according to the present invention may comprise a source of motive power, a vehicle incorporating the source of motive power or other equipment that may make up, or be used in conjunction with, the vehicle or source of motive power. Furthermore, variations on the terms “automobile”, “automotive”, “vehicular” or the like are meant to be construed generically unless the context dictates otherwise. As such, reference to an automobile will be understood to cover cars, trucks, buses, motorcycles and other similar modes of transportation unless more particularly recited in context.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A cooling system for a plurality of vehicular battery cells, said cooling system comprising at least one cooling fin placed in thermal communication with at least two of said plurality of battery cells, said at least one cooling fin comprising a cooling surface thereon that defines a plurality of portions a first of which promotes laminar flow of a coolant to define a relatively low heat rejection per degree inlet temperature differential and a second of which promotes turbulent flow of said coolant to define a relatively high heat rejection per degree inlet temperature differential such that upon an exchange of heat between said at least one cooling fin and said at least two battery cells, said relatively low and high heat rejection per degree inlet temperature differentials cooperate to provide a substantially uniform temperature between a first of said at least two battery cells and a second of said at least two battery cells.

2. The cooling system of claim 1, wherein said at least one cooling fin and said at least two of said plurality of battery cells comprise a substantially planar construction such that an adjacently-facing relation is formed between them.

3. The cooling system of claim 2, wherein said at least one cooling fin comprises a plurality of cooling fins substantially aligned along an axis that is substantially normal to said cooling surface such that upon such alignment, a gap defining a coolant flow-path is formed between adjacent ones of said plurality of cooling fins.

4. The cooling system of claim 2, wherein said at least one cooling fin is cooperatively aligned with said at least two of said plurality of battery cells to define a coolant flow-path therebetween.

5. The cooling system of claim 1, wherein said cooling system is configured as a series cooling system.

6. The cooling system of claim 1, further comprising an exhaust path fluidly disposed between said plurality of portions of said at least one cooling surface such that at least some of the heat transferred to said at least one cooling fin is removed by said coolant through said exhaust path to avoid having said second of said at least two battery cells be thermally exposed with said coolant that is routed through said exhaust path.

7. The cooling system of claim 1, further comprising a discrete channel placed in fluid communication with said portion of said at least one cooling surface that promotes turbulent flow such that at least some of the heat transferred to said at least one cooling fin by said first of said at least two battery cells is removed by said coolant through said discreet channel to reduce thermal exposure of said second of said at least two battery cells to that portion of said at least one cooling surface that promotes turbulent flow.

8. The cooling system of claim 7, further comprising an exhaust path fluidly disposed between said plurality of portions of said at least one cooling surface such that at least some of the heat transferred to said at least one cooling fin is removed by said coolant through said exhaust path to avoid having said second of said at least two battery cells be thermally exposed with said coolant that is routed through said exhaust path.

9. The cooling system of claim 6, wherein at least one of said laminar flow portion and said turbulent flow portion of a surface region of said at least one cooling fin that is adjacent said second of said at least two battery cells is different than said laminar flow portion and said turbulent flow portion of a surface region of said at least one cooling fin that is adjacent said first of said at least two battery cells.

10. The cooling system of claim 1, wherein said turbulent portion of said at least one cooling fin comprises a plurality of turbulators on said cooling surface.

11. The cooling system of claim 10, wherein at least one of said plurality of turbulators, said discreet channel and said exhaust path are tunable to vary an amount of heat exchange between said at least one cooling fin and at least one of said plurality of battery cells.

12. The cooling system of claim 1, further comprising at least one of a discreet channel and an exhaust path for supplemental removal of said coolant, wherein at least one of said plurality of turbulators, said discreet channel and said exhaust path are tunable to vary an amount of heat exchange between said at least one cooling fin and at least one of said plurality of battery cells.

13. The cooling system of claim 1, further comprising at least one insulator plate placed in a substantially facing arrangement between at least one of said cells and at least one of said cooling fins such that heat transfer between them is reduced.

14. A propulsion system for an automobile, said propulsion system comprising at least one battery module comprising:
a plurality of battery cells configured to deliver electric current for motive power for said automobile; and
at least one cooling fin placed in thermal communication with at least two of said plurality of battery cells, said at least one cooling fin comprising a cooling surface thereon that defines a plurality of portions a first of which promotes laminar flow of a coolant flow-path with a relatively low heat rejection per degree inlet temperature differential and a second of which promotes turbulent flow of said coolant flow-path with a relatively high heat rejection per degree inlet temperature differential such that upon an exchange of heat between said at least one cooling fin and said at least two battery cells, said relatively low and high heat rejection per degree inlet temperature differentials cooperate to provide a substantially uniform temperature between a first of said at least two battery cells and a second of said at least two battery cells.

15. A method of controlling temperature in an automobile propulsion system, said method comprising:
configuring said propulsion system to comprise a plurality of battery cells such that current generated thereby provides at least a portion of motive power to an automobile;
arranging at least one cooling fin to be in thermal communication with at least two battery cells of said plurality, said at least one cooling fin comprising a cooling surface thereon that defines a plurality of portions a first of which promotes laminar flow of a coolant flow-path with a relatively low heat rejection per degree inlet temperature differential and a second of which promotes turbulent flow of said coolant flow-path with a relatively high heat rejection per degree inlet temperature differential; and
transferring at least a portion of the heat contained within at least two battery cells of said plurality to said at least one cooling fin such that said relatively low and high heat rejection per degree inlet temperature differentials cooperate to provide a substantially uniform temperature between a first of said at least two battery cells and a second of said at least two battery cells.

16. The method of claim 15, wherein said coolant flow-path is kept in at least a predominantly laminar flow condition while passing over said first of said at least two battery cells.

17. The method of claim 16, wherein said coolant flow-path is kept in at least a predominantly turbulent flow condition while passing over said second of said at least two battery cells.

18. The method of claim 17, further comprising an exhaust path fluidly disposed between said plurality of portions of said at least one cooling surface such that at least some of the heat transferred to said at least one cooling fin is removed by said coolant through said exhaust path to avoid having said second of said at least two battery cells be thermally exposed with said coolant that is routed through said exhaust path.

19. The method of claim 17, further comprising a discrete channel placed in fluid communication with said portion of said at least one cooling surface that promotes turbulent flow such that at least some of the heat transferred to said at least one cooling fin by said first of said at least two battery cells is removed by said coolant through said discreet channel to reduce thermal exposure of said second of said at least two battery cells to that portion of said at least one cooling surface that promotes turbulent flow.

20. The method of claim 15, wherein at least one of said first and second portions comprise a plurality of turbulators formed on said surface thereof, said plurality of turbulators and said exhaust path are tunable to vary an amount of heat exchange between said at least one cooling fin and at least one of said plurality of battery cells.
